(19) United States
(12) Patent Application Publication
(10) Pub. No.: US 2026/0285343 A1
(43) Pub. Date: Sep. 24, 2026

(54) SYSTEM AND METHOD FOR PREVENTING SUDDEN UNINTENDED ACCELERATION OF VEHICLE

(71) Applicant: HL Mando Corporation, Pyeongtaek-si (KR)

(72) Inventors: Jongick WON, Pyeongtaek-si (KR); Eunjung NO, Pyeongtaek-si (KR)

(73) Assignee: HL Mando Corporation, Pyeongtaek-si (KR)

(21) Appl. No.: 19/576,568

(22) Filed: Mar. 24, 2026

(30) Foreign Application Priority Data
Mar. 24, 2025 (KR) 10-2025-0037466
Mar. 12, 2026 (KR) 10-2026-0045028

(51) Int. Cl. B60W 50/12; B60W 10/04; B60W 10/18; B60W 10/20; B60W 30/09; G06V 20/59; G10L 25/63

(52) U.S. Cl. CPC B60W 50/12; B60W 10/04; B60W 10/18; B60W 10/20; B60W 30/09; G06V 20/597; G10L 25/63; B60W 2420/403; B60W 2420/408; B60W 2420/54; B60W 2520/10; B60W 2540/106; B60W 2540/21; B60W 2540/22; B60W 2540/30; B60W 2554/801; B60W 2554/802; B60W 2710/18; B60W 2710/207

(57) ABSTRACT

The present disclosure relates to a sudden unintended acceleration prevention system and method for a vehicle. Specifically, the sudden unintended acceleration prevention system for a vehicle according to the present disclosure comprises: an vehicle interior recognition unit configured to receive information on a behavior and speech of a driver, and vehicle network data, and determine whether there is an acceleration or operation abnormality independent of a driver's intention by analyzing the behavior, the speech, and the vehicle network data using at least one trained model, to generate a situation mode flag; an vehicle exterior recognition unit configured to be activated if the situation mode flag generated from the vehicle interior recognition unit indicates a sudden unintended acceleration situation, identify a surrounding environment and a driving state of the vehicle, and determine path planning to generate a target driving path for stopping or avoiding; and a vehicle controller configured to control a steering, braking, and driving system of the vehicle based on the target driving path input from the vehicle exterior recognition unit to stepwise control a brake pressure in the sudden unintended acceleration situation to induce deceleration of the vehicle or stop the vehicle.

### CROSS-REFERENCE TO RELATED PATENT APPLICATION

This application claims the benefit of Korean Patent Application Nos. 10-2026-0045028, filed on Mar. 12, 2026, and 10-2025-0037466, filed on Mar. 24, 2025, in the Korean Intellectual Property Office, the disclosure of which is incorporated herein in its entirety by reference.

### TECHNICAL FIELD

The present embodiments relate to a system and method for preventing sudden unintended acceleration of a vehicle.

### DESCRIPTION OF RELATED ART

Acceleration and braking control of a vehicle are required to be precisely performed according to a driver's intention, and in particular, accelerator pedal and brake pedal operations are key elements directly related to vehicle driving stability. However, in an actual driving environment, there is a possibility that unintended acceleration may occur due to various factors such as a driver's foot movement error, pedal position confusion, and judgment delay in an urgent situation. In addition, cases have been reported in which a vehicle accelerates regardless of the driver's intention due to electronic factors such as signal mismatch between electronic control units of the vehicle, sensor malfunction, and communication delay, and such suspected sudden unintended acceleration situations may cause a high risk of accidents.

Conventional vehicle control systems determine a driving state based on vehicle network data such as an accelerator pedal opening amount, engine speed, and vehicle speed, but it is difficult to accurately determine whether there is a discrepancy between a driver's actual behavior and a state of the vehicle using only the corresponding data. That is, even when an acceleration signal is output in the vehicle network data, it is not possible to determine whether the driver is actually stepping on the accelerator pedal, and thus an additional determination element is required to detect a discrepancy between the driver's intention and a vehicle control signal.

In addition, in an environment where in-vehicle speech, external vehicle noise, engine sound, road friction sound, and the like are mixed, it is difficult to accurately analyze only the driver's speech, and conventional systems are not sufficiently equipped with a function for detecting a panic state based on a speech signal reflecting psychological characteristics such as the driver's tone, speech pattern, and intonation change in an emergency situation.

Meanwhile, surrounding environment recognition technology for a vehicle is mainly used for driving assistance functions such as lane keeping, obstacle avoidance, and automatic braking, but in order to respond to a situation where in-vehicle and external vehicle situations are complexly intertwined, such as sudden unintended acceleration, behavior and speech signals collected inside the vehicle and external vehicle sensor information need to be integratedly analyzed. Since the conventional technology sets an avoidance path or performs automatic braking based only on external vehicle sensor information, there is a limitation in that one-way control is performed without reflecting the driver's behavior and psychological state.

Therefore, there is a need for a technology capable of accurately detecting a discrepancy between a driver's intention and a vehicle operation state by analyzing the driver's behavior, speech, and vehicle network data in real time, and determining a suspected sudden unintended acceleration situation at an early stage.

### CONTENTS OF INVENTION

### Technical Objective

In this background, the present disclosure is intended to provide a vehicle control technology capable of automatically analyzing a driver's state and operation intention based on a driver's behavior image, speech, and vehicle network data, and preventing a sudden unintended acceleration situation by detecting sudden acceleration or operation abnormality independent of the driver's intention at an early stage.

In addition, unlike the technology that relies on a single information source, the present disclosure is intended to provide a vehicle control technology capable of increasing reliability of sudden unintended acceleration determination by cross-validating a driver's behavior, speech, and vehicle network data to detect a discrepancy between information.

### Technical Solution

In one aspect, the present disclosure provides a sudden unintended acceleration prevention system for a vehicle, comprising: an vehicle interior recognition unit configured to receive information on a behavior and speech of a driver, and vehicle network data, and determine whether there is an acceleration or operation abnormality independent of a driver's intention by analyzing the behavior, the speech, and the vehicle network data using at least one trained model, to generate a situation mode flag; an vehicle exterior recognition unit configured to be activated when a situation mode flag generated from the vehicle interior recognition unit indicates a sudden unintended acceleration situation, recognize a surrounding environment and a driving state of the vehicle, and determine path planning to generate a target driving path for stopping or avoiding; and a vehicle controller configured to control a steering, braking, and driving system of the vehicle based on the target driving path input from the vehicle exterior recognition unit to stepwise control a brake pressure in the sudden unintended acceleration situation to induce deceleration of the vehicle or stop the vehicle.

In another aspect, the present disclosure provides a vehicle interior recognition device comprising: an internal camera configured to photograph a body movement of a driver to acquire image data; a microphone configured to collect a speech signal of the driver; a motion detection model configured to receive the image data and vehicle network data and analyze an operation behavior of the driver; and a speech recognition model configured to receive the speech signal and analyze a speech content and an acoustic feature of the driver.

In another aspect, the present disclosure provides a sudden unintended acceleration prevention method for a vehicle, comprising: receiving information on a behavior and speech of a driver, and vehicle network data, and determining whether there is an acceleration or operation abnormality independent of a driver's intention by analyzing the behavior, the speech, and the vehicle network data using at least one trained model, to generate a situation mode flag; being activated when the generated situation mode flag indicates a sudden unintended acceleration situation to recognize a surrounding environment and a driving state of the vehicle, and determining path planning to generate a target driving path for stopping or avoiding; and controlling a steering, braking, and driving system of the vehicle based on the target driving path to stepwise control a brake pressure in the sudden unintended acceleration situation to induce deceleration of the vehicle or stop the vehicle.

### Effect

According to the present disclosure, even if a driver boarding a vehicle changes, whether sudden unintended acceleration occurs can be automatically determined by comprehensively comparing and cross-verifying the driver's behavior, speech, and vehicle network data, so that safety can be improved by detecting a driver's operation mistake (e.g., driver misoperation, driver misapplication) or an unintended acceleration situation at an early stage based on a discrepancy pattern between pieces of information beyond simple information collection.

In addition, according to the present disclosure, by combining driver behavior analysis and speech-based panic detection, precise determination of sudden unintended acceleration considering even a psychological and behavioral abnormality of the driver beyond a simple pedal signal abnormality is possible, so that accuracy in responding to a dangerous situation can be significantly increased.

In addition, according to the present disclosure, after determining sudden unintended acceleration, an optimal target path for stopping or avoiding can be automatically set by recognizing a surrounding environment and a driving state of the vehicle in real time through an vehicle exterior recognition unit and performing path planning.

In addition, according to the present disclosure, since a vehicle controller performs complex control of stepwise controlling a brake pressure and finely adjusting a steering angle, stable deceleration or stopping is supported while suppressing sliding of the vehicle, thereby improving overall vehicle driving safety.

### BRIEF DESCRIPTION OF DRAWINGS

FIG. 1 is a configuration diagram of a sudden unintended acceleration prevention system for a vehicle according to an embodiment of the present disclosure.

FIG. 2 is a flowchart illustrating a sudden unintended acceleration prevention method for a vehicle according to an embodiment of the present disclosure.

FIG. 3 is a diagram exemplarily illustrating an overall configuration of a sudden unintended acceleration prevention system for a vehicle and a functional relationship between each component according to an embodiment of the present disclosure.

FIG. 4 is a diagram exemplarily illustrating an input signal comparison scenario for distinguishing between a driver misapplication situation, a pedal input error situation, and a sudden unintended acceleration situation according to an embodiment of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components comprising herein will be omitted when it is determined that the description may make the subject matter in some embodiments of the present disclosure rather unclear. The terms such as “comprising”, “having”, “containing”, “constituting” “making up of”, and “formed of” used herein are generally intended to allow other components to be added unless the terms are used with the term “only”. As used herein, singular forms are intended to comprise plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be comprised in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an element or features, or corresponding information (e.g., level, range, etc.) comprise a tolerance or error range that may be caused by various factors (e.g., process factors, internal or external impact, noise, etc.) even when a relevant description is not specified. Further, the term “may” fully encompasses all the meanings of the term “can”.

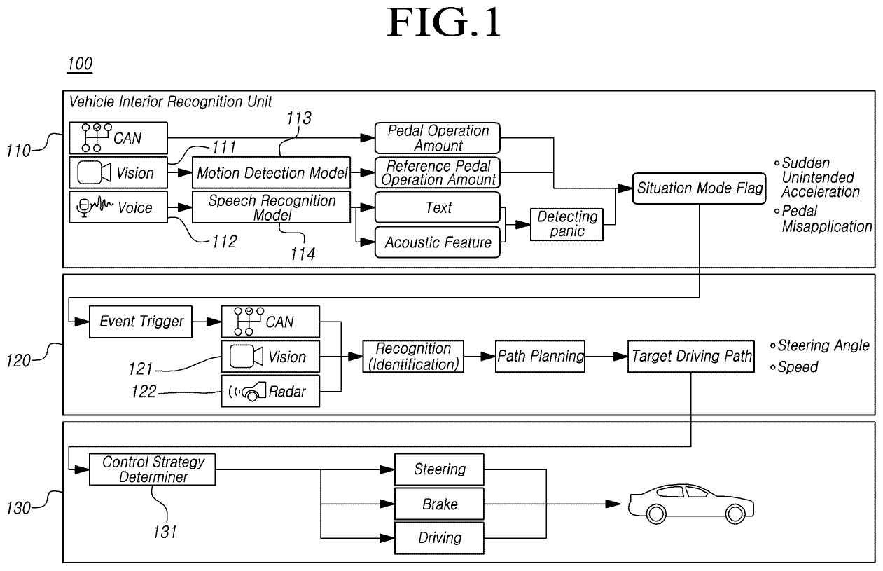

FIG. 1 is a configuration diagram of a sudden unintended acceleration prevention system for a vehicle according to an embodiment of the present disclosure.

Referring to FIG. 1, a vehicle sudden unintended acceleration prevention system 100 may comprise a vehicle interior recognition unit 110, a vehicle exterior recognition unit 120, and a vehicle controller 130.

The vehicle interior recognition unit 110 may have a configuration for recognizing a state of a driver and an operating state of a vehicle, and may comprise vehicle network data (CAN), an internal camera 111, and a microphone 112.

The vehicle network data (CAN) is data collected through communication between electronic control units (ECUs) within the vehicle, and may comprise vehicle operating state information such as an opening amount of an accelerator pedal, whether a brake pedal is operated, a steering angle, and an engine speed (RPM).

The vehicle network data (CAN) may be converted into data indicating pedal usage or pedal operation amount, which numerically expresses the extent to which a driver actually performed acceleration or braking. In this specification, pedal usage is used with the same meaning as pedal operation amount.

The vehicle interior recognition unit 110 may calculate a reference pedal usage or a reference pedal operation amount (Pedal Usage (ref)) based on average pedal usage data in a normal driving state and store data corresponding to the a reference pedal usage as a comparison reference. That is, the reference pedal usage indicates a normal operating state according to a driver's usual pattern, and abnormal acceleration may be determined if the actual pedal usage exceeds a predetermined error from the reference value.

The vehicle interior recognition unit 110 may calculate the reference pedal usage or a reference pedal operation amount (Pedal Usage (ref)) by collecting time-based pedal input data in a normal driving state and statistically analyzing a driver's average accelerator pedal opening amount, brake pedal operation frequency, pedal operation duration, and intervals between pedal operations.

The vehicle interior recognition unit 110 may calculate an average value, a deviation, a mode, and the like of pedal usage patterns based on historical data collected under various road conditions (e.g., urban, high-speed, congested situations) and speed ranges, and may store these patterns as a normal operation reference if they are stably maintained for a specific time interval.

The vehicle interior recognition unit 110 may detect a case where an actual pedal input exceeds a predetermined error range compared to the reference value, and if such an error persists for a specific period of time rather than a single frame, it may be utilized as a primary basis for determining abnormal operation or the possibility of sudden acceleration.

The internal camera 111 may acquire physical behavior data of a driver by capturing images of the driver's body movements (e.g., foot movements, hand movements, upper body tilting, gaze direction, etc.).

Image or video data acquired from an internal camera 111 may be input to a motion detection model 113.

The motion detection model 113 may analyze video frame data of a driver to recognize whether a pedal operation motion has occurred, an operation timing, an operation position, and the like. The motion detection model 113 may compare real-time pedal usage (or actual pedal operation amount) input from CAN data with reference pedal usage (or reference pedal operation amount) generated based on a learned driving pattern, calculate a difference between the two values, and determine whether abnormal acceleration has occurred based on the result. In this case, the motion detection model 113 may classify a case where the difference exceeds a predetermined threshold or a case where accelerator pedal usage rapidly increases despite no foot movement of the driver being detected, as an abnormal pattern.

Further, the motion detection model 113 may extract features such as pedal operation timing, operation intensity, and operation duration from driver's video data and CAN data collected in a normal driving section, and average these features over a plurality of driving cases to learn a normal operation pattern for each driver. The reference pedal usage (or reference pedal operation amount) generated according to the learning result may be updated for each driver or for each driving condition, and may thereafter be utilized for comparison and determination with real-time input pedal usage (or actual pedal operation amount).

Further, the motion detection model 113 may analyze both a rate of change and a duration of pedal usage to distinguish whether it is a simple momentary misoperation or a state where the vehicle is unintentionally accelerating.

For example, the motion detection model 113 may determine a situation where an acceleration signal continuously increases in CAN data despite the driver's foot not moving to a pedal or being in a brake position, as a suspected sudden unintended acceleration situation. This determination result may thereafter be integrated with a panic detection result of a speech recognition model 114 and utilized as basic data for generating a situation mode flag for comprehensive analysis of the driver's behavior, voice, and vehicle state.

A microphone 112 may collect a driver's voice signal or a driver's speech signal.

A speech recognition model 114 may analyze the driver's speech signal input from the microphone 112 to convert the driver's speech content into text data and simultaneously extract acoustic features (e.g., volume, frequency, amplitude change, etc.).

The speech recognition model 114 may learn a plurality of speech data collected from the driver during normal driving to establish a normal speech pattern, such as the driver's usual conversation tone, speech interval, intonation, and speech intensity, as a reference model. This learning may be performed according to characteristics of each driver (e.g., gender, age, speech speed, etc.), and a normal speech pattern may be defined based on statistical feature values such as average speech interval, average frequency distribution, and volume distribution.

When a real-time speech signal collected during driving is input, the speech recognition model 114 may compare it with the learned reference pattern to detect an abnormal speech state.

In particular, the speech recognition model 114 may not analyze text and acoustic data separately, but may integrate them to comprehensively determine whether panic state is present. That is, if urgent vocabulary such as “Brake!”, “What's wrong!”, “Stop!” is detected as a result of text analysis, and at the same time, the volume abnormally increases or high-frequency components rapidly increase in acoustic analysis, the speech recognition model 114 may classify this state as a panic state.

Further, the speech recognition model 114 may determine a panic state even when an imbalance in voice intensity is detected, such as when utterance intervals rapidly shorten and an intonation change rate rapidly increases.

Based on such text-acoustic integrated analysis results, the speech recognition model 114 may determine the driver's psychological state (e.g., calm, surprised, panic, etc.), and if a panic state is determined, transmit the result (e.g., Panic Detection) to the vehicle interior recognition unit 110 to be utilized as auxiliary data for determining whether the sudden unintended acceleration has occurred.

The vehicle interior recognition unit 110 may comprehensively analyze the driver's behavior analysis results (e.g., foot movement, hand movement, gaze direction, etc.) output from the motion detection model 113, the comparison result between pedal usage and reference pedal usage, and the panic detection result output from the speech recognition model 114.

The vehicle interior recognition unit 110 may receive behavior analysis results such as foot position, direction of toe movement, pedal approach trajectory, hand movement, and gaze direction extracted from the motion detection model 113, and cross-reference actual pedal operation and operation intention.

The vehicle interior recognition unit 110 may simultaneously quantitatively calculate a difference between pedal usage and reference pedal usage, and detect a possibility of abnormal operation if a discrepancy pattern is detected, such as when the difference rapidly increases or, an acceleration signal is output despite the brake pedal being depressed.

The vehicle interior recognition unit 110 may consider panic detection response signals output from the speech recognition model 114, such as the driver's utterance interval, speech intensity (e.g., volume) change, heightened intonation, screaming, or expressions of confusion, to determine whether the driver is accurately performing an operation intention or whether a sudden psychological or mental reaction has occurred.

The multiple analysis results may be utilized as basic data for detecting the possibility of abnormal operation with high reliability by integrally determining the consistency among behavior, speech, and pedal input, rather than merely observing vehicle operation signals.

Further, the vehicle interior recognition unit 110 may determine whether sudden unintended acceleration or abnormal operation has occurred by considering the aforementioned results and vehicle operation states collected from CAN data, and may generate a situation mode flag based on the determination result. Herein, the situation mode flag indicates at least one of an unintended acceleration state, which represents an unintended rapid acceleration state, or a pedal misapplication state, which represents a driver's foot operation error, and may be transmitted to the vehicle exterior recognition unit 120 to be utilized as a trigger signal for vehicle control determination.

The vehicle interior recognition unit 110 may evaluate the discrepancy between the driver's intention and the actual vehicle operation by comprehensively determining through cross-referencing the driver's behavior analysis results, pedal operation comparison results, speech-based panic detection results, and actual vehicle operation signals (e.g., accelerator pedal opening amount, brake signal status, steering angle displacement) collected from CAN data.

The vehicle interior recognition unit 110 may generate a situation mode flag indicating one of unintended acceleration, pedal misapplication, or normal driving based on such a determination, and the situation mode flag may be immediately transmitted to the vehicle exterior recognition unit 120 to be used as a trigger signal for determining a driving path and whether to evade or stop.

The vehicle interior recognition unit 110, since it considers the consistency of multiple elements rather than a single element, temporal flow, and pattern persistence when generating the situation mode flag, may perform a stable determination by excluding temporary false reactions or noise, thereby enabling early identification of suspected sudden unintended acceleration situations and securing the reliability of subsequent control stages.

The vehicle exterior recognition unit 120 may have a configuration for recognizing the vehicle's surrounding environment, and may comprise an event trigger, vehicle network data (CAN), an external camera 121, and a radar 122.

The vehicle exterior recognition unit 120 receives the situation mode flag from the vehicle interior recognition unit 110, and may activate the event trigger if a sudden unintended acceleration situation is determined.

Specifically, the vehicle exterior recognition unit 120, by analyzing the type, occurrence time, and duration of the situation mode flag, may primarily verify whether actual risk exists. In addition, if the flag satisfies a specific threshold condition, the vehicle exterior recognition unit 120 may consider this situation as an emergency situation and switch external sensors and CAN processing modules to a high-speed monitoring mode. Further, if the event trigger is activated, the vehicle exterior recognition unit 120 collects surrounding environment data at a higher frequency sampling rate than usual, and may improve the speed and accuracy of external situation determination by operating a path obstacle detection algorithm.

The vehicle exterior recognition unit 120, when the event trigger occurs, based on data input from CAN data, the external camera 121, and the radar 122, may integrally perceive obstacles, lanes, road boundaries around the vehicle, and the vehicle's current driving state (e.g., speed, steering angle, acceleration state).

The vehicle exterior recognition unit 120 collects driving state information such as vehicle speed, acceleration, steering angle, and vehicle posture (e.g., Yaw/Roll/Pitch) from CAN data, and may acquire lane recognition information, object detection information, and road condition (e.g., road markings, construction zones) information based on RGB images from the external camera 121. Further, the radar 122, by measuring distance and speed changes, may calculate the distance to a preceding vehicle (e.g., Time Gap), rate of closure or rage of approach, and potential collision threat level.

The vehicle exterior recognition unit 120, by integrating such heterogeneous sensor data through time synchronization and coordinate transformation, may generate a 360° surrounding perception map, and may perform real-time situation determination based thereon.

The vehicle exterior recognition unit 120, based on the perception results, determines a path planning, and may generate a desired driving path for safe stopping or avoidance. The generated desired path comprises vehicle steering angle information and velocity information, and may thereafter be transmitted to the control strategy determiner 131 to be utilized as a reference for vehicle braking and steering control commands.

The vehicle exterior recognition unit 120, by considering relative speeds with surrounding vehicles, road width, lane curvature, obstacle positions, and the like, after generating a plurality of candidate driving paths that the vehicle can select, by evaluating collision possibility, steerability, braking distance, road stability, and the like for each candidate path, may select the path with the lowest risk. Thereafter, the selected desired path is configured to comprise information such as the vehicle's steering angle, target deceleration amount, deceleration timing, and avoidance direction, and may be transmitted to the control strategy determiner 131 of the vehicle controller 130 to be utilized as a reference signal for actual braking and steering control.

The vehicle controller 130 may have a configuration for controlling the vehicle's steering, braking, and powertrain systems (or driving system), and may comprise a control strategy determiner 131.

The control strategy determiner 131 receives the desired driving path from the vehicle exterior recognition unit 120, and may control the vehicle's steering, braking, and powertrain based on the desired driving path.

The control strategy determiner 131, by interpreting control parameters such as steering angle change amount, deceleration demand, and obstacle avoidance direction included in the desired driving path in real-time, may generate a steering motor driving signal, a brake pressure adjustment signal, and an engine/motor output control signal corresponding to the parameters.

The control strategy determiner 131, when determined to be in a sudden unintended acceleration situation, is capable of controlling the steering angle and the brake pressure of the vehicle by comprehensively analyzing the desired driving path transmitted from the vehicle exterior recognition unit 120, and information regarding the vehicle's speed, vehicle body posture, and road surface conditions.

The control strategy determiner 131, when determined to be in a sudden unintended acceleration situation, is capable of finely adjusting the steering angle and the brake pressure of the vehicle by comprehensively analyzing driving state data such as not only the desired driving path transmitted from the vehicle exterior recognition unit 120 but also the vehicle's speed, vehicle body posture (e.g., changes in vehicle body roll, pitch, and yaw), and road surface conditions (e.g., friction coefficient, gradient). In this case, the control strategy determiner 131 adjusts a brake control curve so as not to excessively increase the brake pressure when the vehicle posture is unstable during high-speed driving or when the road surface friction is low, and is capable of gradually adjusting the amount of steering angle change within a range that maintains the stability of the vehicle.

The control strategy determiner 131, when the current speed of the vehicle is higher than a target deceleration speed, is capable of inducing deceleration while preventing the vehicle from skidding during sudden braking by gradually increasing the brake pressure transmitted to each wheel.

The control strategy determiner 131 is capable of preventing vehicle skidding or wheel lock-up during sudden braking by real-time monitoring of a wheel speed sensor signal, calculating a wheel slip ratio, and by adjusting a brake pressure increase rate so that the slip ratio does not exceed a specific threshold. Furthermore, the control strategy determiner 131 is capable of securing the straight-line stability of the vehicle by finely balancing the brake pressure for each wheel in conjunction with an ABS control module and an ESC control module at each brake pressure increase step.

The control strategy determiner 131 is capable of controlling the vehicle to move in a direction free from collision risk or to prevent the vehicle from departing from a lane by utilizing direction and distance information of an obstacle obtained from the vehicle exterior recognition unit 120 and by finely adjusting the steering angle.

The control strategy determiner 131, when an obstacle is detected on the front left side of the vehicle, calculates a collision probability and, considering the vehicle's speed and lane position, is capable of forming a safe avoidance trajectory by gradually applying a steering angle to the right. Furthermore, the control strategy determiner 131 is capable of performing avoidance control by considering a lane keeping assist signal and lane boundary recognition results together, thereby limiting the maximum amount of steering angle change so that the vehicle does not depart from the lane.

The control strategy determiner 131, while simultaneously performing brake and steering control, is capable of stably stopping the vehicle by maintaining the brake pressure and cutting off the driving output when the speed of the vehicle decreases below a threshold. Through this, the vehicle can secure driving stability even in a sudden unintended acceleration situation and can be controlled to enable safe stopping or avoidance.

The control strategy determiner 131 minimizes or completely cuts off the output of the vehicle's powertrain (e.g., engine or motor) and, by controlling the brake pressure to be maintained at a level that does not cause unnecessary shaking of the vehicle, is capable of controlling the braking system so that creeping or vibration does not occur when the vehicle stops. Simultaneously, by slowly returning the steering angle to a straight-ahead direction, the control strategy determiner 131 is capable of controlling the vehicle to maintain a stable posture after stopping.

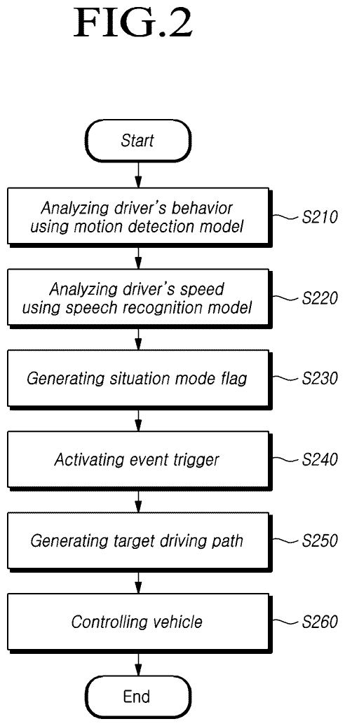

FIG. 2 is a flowchart illustrating a method for preventing sudden acceleration of a vehicle according to an embodiment of the present disclosure.

Referring to FIG. 2, a vehicle interior recognition unit 110 is capable of analyzing a driver's behavior through a motion detection model 113 (S210).

Specifically, the motion detection model 113 receives video frames acquired in real-time from an internal camera 111 and is capable of analyzing physical movements such as the driver's foot movements, hand movements, upper body movements, face direction, and gaze direction. The motion detection model 113 is capable of identifying the driver's movement state by estimating change patterns between video frames, position information of major body parts, and movement trajectories.

The motion detection model 113, based on the analyzed movement patterns, is capable of identifying whether the driver is operating an accelerator pedal or a brake pedal, and by detecting movements of the foot towards the pedal, whether the pedal is touched, and the rotation direction of the toes or ankle, is capable of determining the timing and accuracy of the operation. Furthermore, the motion detection model 113 is capable of confirming whether there is an intention to operate the pedal by analyzing whether a preceding movement exists immediately before the driver presses the pedal.

Furthermore, the motion detection model 113, by referring to vehicle operation information such as accelerator pedal opening, brake signals, and steering angle, which are comprised in vehicle network data (CAN), is capable of verifying the consistency between image-based or video-based behavior analysis results and actual vehicle operation signals. For example, even if an acceleration signal is output from the vehicle network data, if the internal camera analyzes that a foot is not placed on the accelerator pedal, or if the vehicle maintains an acceleration state despite the internal camera analyzing that a foot is positioned on the brake pedal, the system is capable of determining that the driver's operation intention and the vehicle's operating state are inconsistent.

Furthermore, the motion detection model 113, by analyzing the temporal flow of video data and vehicle network data and by tracking pedal operation timing, operation duration, and change speed, is capable of determining whether abnormal operation exists compared to a normal driving pattern. Such analysis can be utilized as a basis for distinguishing between momentary pedal misoperation and a continuous abnormal acceleration state.

Accordingly, the motion detection model 113, by comprehensively analyzing the consistency between the driver's actual behavior and the vehicle's actual operation signals, is capable of providing core basic data for determining whether the sudden unintended acceleration has occurred.

Next, the vehicle interior recognition unit 110 is capable of analyzing the driver's voice through the voice recognition model 114 (S220).

Specifically, the speech recognition model 114 may collect a speech signal input in real time from the microphone 112, divide the speech signal based on a time axis, and analyze a volume (or speech intensity), a frequency distribution, an amplitude change, and the like of each section to extract an acoustic feature.

In addition, the speech recognition model 114 may convert a speech content of the driver from the speech signal into text data using a natural language processing-based text conversion engine together with the extracted acoustic feature.

For example, if the speech of the driver shows an abnormally high volume or an urgent breathing pattern different from usual, or the driver makes repetitive speech at short intervals, the speech recognition model 114 may compare a pattern corresponding to this situation with a normal pattern to determine an abnormal speech state. In addition, if a specific type of intonation rise, a rapid frequency change, or an irregularity of a speech waveform appears during speech, this state may be classified as a panic state.

Through such analysis, the speech recognition model 114 may reliably determine whether the speech content and the acoustic feature of the speech signal of the driver indicate an urgent situation, and a corresponding determination result may be transmitted to the vehicle interior recognition unit 110 to be utilized as core auxiliary data for determining the sudden unintended acceleration.

Next, the vehicle interior recognition unit 110 may receive the information on a behavior and speech of the driver, and vehicle network data, and determine whether there is an acceleration or operation abnormality independent of the driver's intention to generate a situation mode flag (S230).

Specifically, the vehicle interior recognition unit 110 may combine a body movement analysis result of the driver output from the motion detection model 113 and a panic detection result output from the speech recognition model 114, and check information such as an accelerator pedal opening amount, a brake signal, an engine speed, and a steering angle input from the vehicle network data (CAN).

For example, the vehicle interior recognition unit 110 may determine that the driver's intention and an actual operation of the vehicle do not match if the accelerator pedal opening amount abnormally increases in a state where a foot movement of the driver is not detected, or if the vehicle is continuously accelerated in a situation where a panic state is detected as a result of speech analysis.

In addition, the vehicle interior recognition unit 110 may compare a reference pedal operation amount (i.e., reference pedal usage) generated during normal driving with a real-time pedal operation amount (i.e., actual pedal usage), and determine that there is a possibility of sudden unintended acceleration if a difference between the a reference pedal operation amount and real-time pedal operation amount of a predetermined threshold value or more continues for a specific period of time or more.

By comprehensively analyzing a plurality of information sources in this way, the vehicle interior recognition unit 110 may reliably detect an abnormal operation or a rapid acceleration state different from the driver's intention, and generate a result as a situation mode flag expressed in at least one form of a sudden unintended acceleration state or a pedal misapplication state to transmit the situation mode flag to the vehicle exterior recognition unit 120.

Next, the vehicle exterior recognition unit 120 may activate an event trigger if the generated situation mode flag indicates a sudden unintended acceleration situation (S240).

Specifically, the vehicle exterior recognition unit 120 performs surrounding environment recognition in a low-power mode or at a reduced resolution during normal driving, but may activate an event trigger to switch to a high-precision recognition mode at a moment when sudden unintended acceleration is detected in the situation mode flag.

For example, if the event trigger is activated, the external camera 121 may increase a frame rate or operate at a night mode, an HDR mode, or the like to enhance a visibility securing capability. The radar 122 may shorten a scan period to more quickly detect changes in distance and speed of relative objects around the vehicle.

In addition, the event trigger may be expanded to collect current driving state data such as speed, a steering angle, and an acceleration state in real time from the vehicle network data (CAN) so as to be reflected in a subsequent path planning step.

Such an event-based processing structure enables immediate high-precision environment recognition in a sudden unintended acceleration situation while reducing unnecessary waste of resources.

Next, the vehicle exterior recognition unit 120 may recognize a surrounding environment and a driving state of the vehicle, and determine path planning to generate a target driving path for stopping or avoiding (S250).

Specifically, after the event trigger is activated, the vehicle exterior recognition unit 120 may integrate and process data input from the external camera 121 and the radar 122 to recognize environmental factors such as an obstacle around the vehicle, a lane boundary, a pedestrian, and a distance between vehicles.

For example, the radar 122 may detect a distance to a preceding vehicle and a relative speed to evaluate a collision possibility, and the external camera 121 may identify a safe path to be maintained by the vehicle by identifying a lane position and a curvature through a lane recognition algorithm. In addition, an immediately applicable driving path may be calculated by reflecting a current speed, a steering angle, and an acceleration state of the vehicle using CAN data.

The vehicle exterior recognition unit 120 may execute a path planning algorithm based on such a recognition result and generate a target driving path (e.g., Desired Path) to move the vehicle in a direction without a collision risk or to perform a stop within a lane. The target driving path may comprise coordinates on a map of the vehicle, a steering angle command value, a target speed value, and the like, and may be transmitted to the vehicle controller 130.

The vehicle controller 130 may control a steering, braking, and driving system of the vehicle based on the target driving path to stepwise control a brake pressure in a sudden unintended acceleration situation to induce deceleration of the vehicle or stop the vehicle (S260).

Specifically, the vehicle controller 130 may generate a control command by considering a current speed, a body posture, a road surface state, and the like of the vehicle together based on steering angle and target speed information for the target driving path transmitted from the vehicle exterior recognition unit 120.

For example, if the speed of the vehicle is higher than a target deceleration speed, the vehicle controller 130 may stepwise increase a brake pressure of each wheel to prevent body slipping or wheel locking that may occur during sudden braking. In addition, if a forward obstacle is located within a specific distance, the vehicle controller 130 may finely adjust the steering angle to perform avoidance control in a direction without a collision risk.

In addition, if the speed of the vehicle decreases below a specific threshold value, the vehicle controller 130 may cut off a driving output (or torque) to completely remove residual acceleration of the vehicle and maintain the brake pressure to ensure a safe stopped state.

Such a control procedure is configured to stably manage a traveling direction and a speed of the vehicle even in a sudden unintended acceleration situation, and finally enables safe deceleration or stopping of the vehicle.

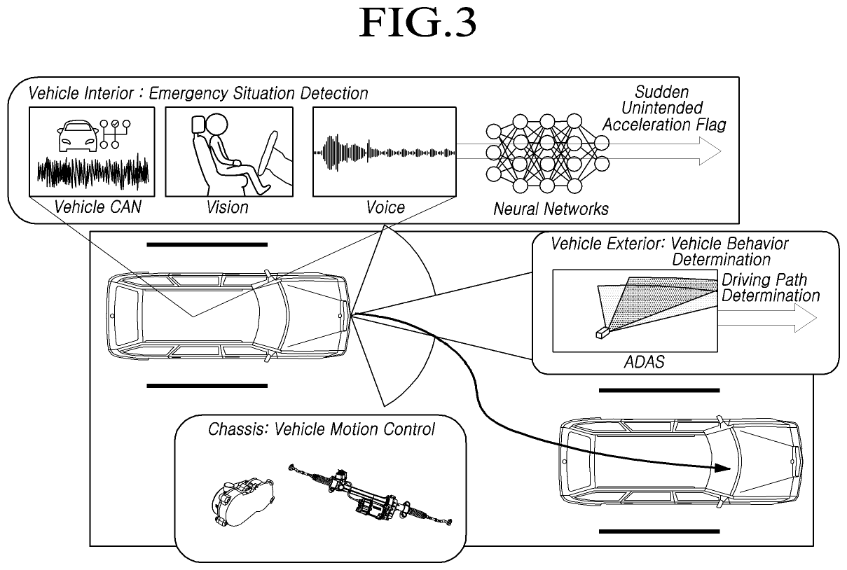

Referring to FIG. 3, the vehicle interior recognition unit 110 may acquire a behavior image of a driver through an internal camera 111, acquire a speech signal of the driver through a microphone 112, and collect vehicle CAN data from a vehicle network. Image data acquired from the internal camera 111 may be input to the motion detection model 113 to extract behavioral features related to a pedal operation, a posture change, and a braking intention of the driver, and speech data acquired from the microphone 112 may be input to the speech recognition model 114 to extract speech features related to a panic state or a braking request. In addition, the vehicle CAN data is vehicle behavior information comprising an accelerator pedal operation amount, a braking signal, a vehicle speed, and a driving state, and may be used together with an output of the motion detection model 113 and an output of the speech recognition model 114 to determine whether there is consistency between a driver's intention and actual vehicle behavior. The vehicle interior recognition unit 110 may determine whether sudden unintended acceleration occurs by comprehensively analyzing the image data, the speech data, and the vehicle CAN data.

Next, the vehicle exterior recognition unit 120 may drive an event trigger if the situation mode flag is activated, and recognize a front and surrounding environment of the vehicle as distance information, speed information, and object recognition data in units of image frames using ADAS sensors (e.g., an external camera and a radar). The vehicle exterior recognition unit 120 may analyze an obstacle on a road, a lane, a movement path of a surrounding vehicle, and the like to perform vehicle behavior determination for avoidance/deceleration purposes to be performed by the vehicle.

Finally, the vehicle controller 130 may control a steering device (e.g., EPS), a braking device, and a powertrain (e.g., driving system) of the vehicle based on the generated target driving path. The vehicle controller 130 may control to perform a stable deceleration or avoidance operation so that the vehicle travels along the target driving path by adjusting the steering angle of the vehicle or stepwise increasing the brake pressure. In particular, the vehicle controller 130 may apply a control strategy for safely stopping the vehicle by cutting off a driving output and maintaining a braking force while deceleration of the vehicle is in progress.

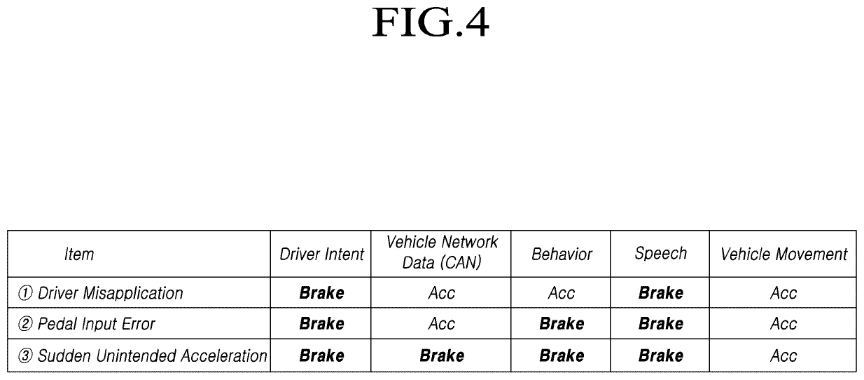

Referring to FIG. 4, a sudden unintended acceleration determination scenario for a vehicle according to an embodiment of the present disclosure may be classified by mutually comparing a driver's intention, vehicle network data (CAN), a driver's behavior, a driver's speech, and actual vehicle behavior or actual vehicle movement.

In each scenario, a driver misapplication, a pedal input error, and a sudden unintended acceleration occurrence situation may be distinguished according to whether there is a mismatch between input signals.

First, in a driver misapplication scenario \textcircled{1}, the driver's intention is confirmed as braking (Brake), but an acceleration (Acc) signal may be detected in the vehicle network data (CAN).

In addition, in a driver's behavior analysis, a foot movement is recognized as moving in an accelerator pedal direction or as an acceleration state, and a speech indicating a braking intention similar to “brake” may be detected in a speech signal.

However, since the actual vehicle behavior still appears as an acceleration state (Acc), this may be determined as a case where the driver intended braking but an actual foot movement or pedal operation was incorrectly performed.

Next, in a pedal input error scenario \textcircled{2}, the driver's intention is confirmed as braking (Brake), and an acceleration (Acc) signal is input in the CAN data, but a foot movement in a braking (Brake) direction may be recognized in the driver's behavior analysis.

Also, a braking request utterance may be detected in the speech, and the vehicle may proceed in an acceleration state (Acc).

In this case, the driver's behavior and speech indicate a braking intention, but since only the CAN signal is input as acceleration, this may be determined as a situation where an acceleration signal is transmitted to the vehicle controller 130 due to an error in a sensor or a pedal input system even though the driver actually depressed a brake pedal.

Finally, in a sudden unintended acceleration occurrence scenario \textcircled{3}, the driver's intention is confirmed as braking (Brake), and the CAN data may also indicate a braking (Brake) state.

Simultaneously, a foot movement in a brake direction is recognized in the driver's behavior analysis, and a braking request or an emergency situation utterance may be detected in the speech.

Nevertheless, an actual movement of the vehicle (e.g., Vehicle Movement) may appear as an acceleration (Acc) state.

As such, a case where the vehicle actually accelerates while all input signals (e.g., driver's intention, CAN, Vision, Voice) consistently indicate the braking state, may be determined as a sudden unintended acceleration situation in which the vehicle performs unintended acceleration regardless of the driver's operation.

Such a scenario configuration of FIG. 4 indicates that the vehicle interior recognition unit may clearly distinguish between a misapplication, a system error, and a sudden unintended acceleration situation by comparing and verifying multi-sensor information.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims.

1. A sudden unintended acceleration prevention system for a vehicle, comprising:
an vehicle interior recognition unit configured to receive information on a behavior and a speech of the driver, and vehicle network data, and determine whether there is an acceleration or operation abnormality independent of a driver's intention by analyzing the behavior, the speech, and the vehicle network data using at least one trained model, to generate a situation mode flag;
an vehicle exterior recognition unit configured to be activated when the situation mode flag generated from the vehicle interior recognition unit indicates a sudden unintended acceleration situation, recognize a surrounding environment and a driving state of the vehicle, and determine path planning to generate a target driving path for stopping or avoiding; and
a vehicle controller configured to control a steering, braking, and driving system of the vehicle based on the target driving path input from the vehicle exterior recognition unit to stepwise control a brake pressure in the sudden unintended acceleration situation to induce deceleration of the vehicle or stop the vehicle.

2. The sudden unintended acceleration prevention system for a vehicle of claim 1, wherein the vehicle interior recognition unit comprises:
an internal camera configured to photograph a body movement of the driver to acquire image data;
a microphone configured to collect a speech signal of the driver;
a motion detection model configured to receive the image data and the vehicle network data and analyze an operation behavior of the driver; and
a speech recognition model configured to receive the speech signal and analyze a speech content and an acoustic feature of the driver.

3. The sudden unintended acceleration prevention system for a vehicle of claim 2, wherein the motion detection model is configured to:
analyze the image data of the driver to identify whether a pedal is operated, an operation timing, and an operation position;
compare a real-time pedal operation amount input from the vehicle network data with a reference pedal operation amount generated based on a learned normal driving pattern to calculate a difference between the real-time pedal operation amount and the reference pedal operation amount; and
determine a case where the difference occurs by a specific threshold value or more, or a case where an accelerator pedal operation amount rapidly increases in a state where a foot movement of the driver is not detected, as a sudden unintended acceleration state.

4. The sudden unintended acceleration prevention system for a vehicle of claim 2, wherein the speech recognition model is configured to:
analyze text data and the acoustic feature from the speech signal of the driver;
determine a case where the speech content of the driver includes an urgent or abnormal meaning and a change in volume, frequency, or amplitude rapidly increases, as a panic state; and
provide a determination result to the vehicle interior recognition unit.

5. The sudden unintended acceleration prevention system for a vehicle of claim 2, wherein the motion detection model is configured to:
learn the image data and the vehicle network data collected in a normal driving section to derive a normal operation pattern for each driver; and
average a pedal operation timing, an operation intensity, and an operation duration based on a learning result to update the reference pedal operation amount for each driver or for each driving condition.

6. The sudden unintended acceleration prevention system for a vehicle of claim 2, wherein the speech recognition model is configured to:
collect a plurality of speech data of the driver during normal driving to statistically analyze a speech interval, an intonation change rate, a frequency distribution, and a speech intensity, thereby learning a normal speech pattern; and
compare with a speech signal input in real time to detect a case where the speech interval is shortened or a high-frequency component rapidly increases, as an abnormal speech.

7. The sudden unintended acceleration prevention system for a vehicle of claim 2, wherein the vehicle interior recognition unit is configured to:
analyze a driver behavior analysis result from the motion detection model, a panic detection result from the speech recognition model, and a vehicle operation state from the vehicle network data;
determine whether there is an acceleration or operation abnormality independent of the driver's intention; and
generate the situation mode flag according to a determination result.

8. The sudden unintended acceleration prevention system for a vehicle of claim 7, wherein the vehicle interior recognition unit is configured to determine the sudden unintended acceleration situation if the driver behavior analysis result indicates a braking operation, the panic detection result indicates a braking request or an emergency situation, the vehicle operation state from the vehicle network data indicates a braking state, and an actual movement of the vehicle is an acceleration state.

9. The sudden unintended acceleration prevention system for a vehicle of claim 1, wherein the vehicle exterior recognition unit comprises:
an external camera configured to acquire an image around the vehicle; and
a radar configured to detect an obstacle in front of or on a side of the vehicle.

10. The sudden unintended acceleration prevention system for a vehicle of claim 9, wherein the vehicle exterior recognition unit is configured to:
activate an event trigger if the situation mode flag indicates a sudden unintended acceleration state;
integrate and process data input from the external camera and the radar according to the activated event trigger to recognize an obstacle, a lane, a road boundary around the vehicle, and a current driving state of the vehicle; and
perform path planning based on a recognition result, and generate the target driving path for stopping or avoiding.

11. The sudden unintended acceleration prevention system for a vehicle of claim 1, wherein the vehicle controller comprises a control strategy determiner configured to receive the target driving path transmitted from the vehicle exterior recognition unit and control the steering, braking, and driving system of the vehicle,
wherein the control strategy determiner is configured to analyze a current speed of the vehicle, a vehicle body posture, and a road surface state to stepwise increase the brake pressure, or finely adjust a steering angle to perform deceleration or avoidance control of the vehicle.

12. A vehicle interior recognition device comprising:
an internal camera configured to photograph a body movement of a driver to acquire image data;
a microphone configured to collect a speech signal of the driver;
a motion detection model configured to receive the image data and vehicle network data and analyze an operation behavior of the driver; and
a speech recognition model configured to receive the speech signal and analyze a speech content and an acoustic feature of the driver.

13. The vehicle interior recognition device of claim 12, wherein the motion detection model is configured to:
analyze the image data of the driver to identify whether a pedal is operated, an operation timing, and an operation position;
compare a real-time pedal operation amount input from the vehicle network data with a reference pedal operation amount generated based on a learned normal driving pattern to calculate a difference between the real-time pedal operation amount and the reference pedal operation amount; and
determine a case where the difference occurs by a predetermined threshold value or more, or a case where an accelerator pedal operation amount rapidly increases in a state where a foot movement of the driver is not detected, as a sudden unintended acceleration state.

14. The vehicle interior recognition device of claim 12, wherein the speech) recognition model is configured to:
simultaneously analyze text data and the acoustic feature from the speech signal of the driver; and
determine a case where the speech content of the driver includes an urgent or abnormal meaning and a change in volume, frequency, or amplitude rapidly increases, as a panic state.

15. The vehicle interior recognition device of claim 12, wherein the motion detection model is configured to:
learn the image data and the vehicle network data collected in a normal driving section to derive a normal operation pattern for each driver; and
average a pedal operation timing, an operation intensity, and an operation duration based on a learning result to update the reference pedal operation amount for each driver or for each driving condition.

16. The vehicle interior recognition device of claim 12, wherein the speech recognition model is configured to:
collect a plurality of speech data of the driver during normal driving to statistically analyze a speech interval, an intonation change rate, a frequency distribution, and a speech intensity, thereby learning a normal speech pattern; and
compare with a speech signal input in real time to detect a case where the speech interval is shortened or a high-frequency component rapidly increases, as an abnormal speech.

17. A sudden unintended acceleration prevention method for a vehicle, comprising:
receiving information on a behavior and speech of a driver, and vehicle network data, and determining whether there is an acceleration or operation abnormality independent of a driver's intention by analyzing the behavior, the speech, and the vehicle network data using at least one trained model, to generate a situation mode flag;
being activated when the generated situation mode flag indicates a sudden unintended acceleration situation to identify a surrounding environment and a driving state of the vehicle, and determining path planning to generate a target driving path for stopping or avoiding; and
controlling a steering, braking, and driving system of the vehicle based on the target driving path to stepwise control a brake pressure in the sudden unintended acceleration situation to induce deceleration of the vehicle or stop the vehicle.

18. The sudden unintended acceleration prevention method for a vehicle of claim 17, wherein the generating of the situation mode flag comprises:
receiving, by a motion detection model, image data and the vehicle network data to analyze an operation behavior of the driver; and
receiving, by a speech recognition model, a speech signal to analyze a speech content and an acoustic feature of the driver.

19. The sudden unintended acceleration prevention method for a vehicle of claim 18, wherein the motion detection model is configured to:
analyze the image data of the driver to identify whether a pedal is operated, an operation timing, and an operation position;
compare a real-time pedal operation amount input from the vehicle network data with a reference pedal operation amount generated based on a learned normal driving pattern to calculate a difference between the real-time pedal operation amount and the reference pedal operation amount; and
determine a case where the difference occurs by a specific threshold value or more, or a case where an accelerator pedal operation amount rapidly increases in a state where a foot movement of the driver is not detected, as a sudden unintended acceleration state.

20. The sudden unintended acceleration prevention method for a vehicle of claim 18, wherein the speech recognition model is configured to:
analyze text data and the acoustic feature from the speech signal of the driver;
determine a case where the speech content of the driver includes an urgent or abnormal meaning and a change in volume, frequency, or amplitude rapidly increases, as a panic state; and
provide a determination result to an vehicle interior recognition unit.
